(19) United States
(12) Patent Application Publication
(10) Pub. No.: US 2012/0315014 A1
(43) Pub. Date: Dec. 13, 2012

(54) AUDIO FINGERPRINTING TO BOOKMARK A LOCATION WITHIN A VIDEO

(76) Inventor: Brian Shuster, Beverly Hills, CA (US)

(21) Appl. No.: 13/551,544

(22) Filed: Jul. 17, 2012

Related U.S. Application Data
(63) Continuation-in-part of application No. 13/158,354, filed on Jun. 10, 2011.
(60) Provisional application No. 61/509,087, filed on Jul. 18, 2011.

(51) Int. Cl. H04N 9/80

(52) U.S. Cl. 386/241; 386/E09.011

(57) ABSTRACT

A method and system for identifying video segments for subsequent playback. Audio from an audio-visual presentation playing on a primary screen device is retrieved using a secondary screen device. At least one audio fingerprint is generated from the retrieved audio. The at least one audio fingerprint is sent to an audio fingerprint server. The audio fingerprint server obtains information identifying the audio-visual presentation and a relative time within the audio-visual presentation corresponding to the at least one audio fingerprint. The obtained information is used for subsequently retrieving the audio video presentation from a video content server.

This is a non-provisional application claiming the benefit of U.S. Provisional Application Ser. No. 61/509,087 filed Jul. 18, 2011, and a continuation-in-part of U.S. application Ser. No. 13/158,354 filed Jun. 10, 2011.

### BACKGROUND OF THE INVENTION

The present invention relates to the field of methods for identifying videos stored on a remote device and playing back the stored video or video segments or clips on a playback device. In the prior art, while watching any form of video program, if it is desired to leave at any point in a program and access it at a later point, the user would need to begin recording the video content using a device such as a video cassette recorder (VCR), Personal Video Recorder (PVR) or digital video recorder (DVR), and then return to the same device at a later time to watch the recorded program. VCRs, since they record to magnetic tape moving linearly, cannot continue to record while in playback mode.

VCR, PVR and DVR technologies allow users to record video while they were watching it on their television. These systems enable users of these devices to leave the room while watching programs and return at a later point in time and rewind to the moment they remembered leaving the program. It also allows users to revisit/replay content at any point in a program. Although, unlike VCRs, PVR/DVR technologies allow a user to “rewind” while a program is still recording, several issues come up with such technology:
PVR/DVR systems need to be physically connected to the source they are recording and to a display.
The user needs to be physically located where the PVR/DVR system is located.
The PVR/DVR needs to be connected to a cable provider.
Users need to purchase a specialized device or purchase a video receiver that has the PVR/DVR technology integrated within it. This can be costly and in the case of integrated units, the unit is often only compatible with certain cable and/or satellite providers requiring the user to replace it when changing providers.
In order to view/play back the content the user needs to be with the PVR/DVR.
Although a user can leave the room and return to a specific portion of the program by using the pause feature, any prolonged absence where another user may be using the unit will result in losing the paused position. If the program material is recorded, the user can of course rewind to the point in time where the user left the or otherwise stopped watching the content. However, the user must rewind through the media and search for the spot where the user stopped watching. In such a case it is up to the user to remember where the user left off and visually recognize that point while rewinding the video at a fast rate.
PVR/DVR technologies only work with on-air/cable/satellite broadcasters, they do not take into consideration other types of programming that are available such as DVD, Internet/Web video, etc.
Video typically takes up a large amount of space on consumer storage system—PVR/DVR technologies have a limited amount of storage.

The invented video bookmarking technology does not have any of these limitations. The end-user/consumer can be in front of any TV/Video screen in any room, in any location without any physical connection to the television/video source. The user can bookmark what the user is watching simply by opening up the application and pressing a bookmark button.

The application automatically recognizes the program being watched and provides a simple method (referred to herein as bookmarking) of returning to the content at a later time.

Bookmarking can be done from any secondary screen device (phone, tablet, PC, etc.) and does not require end-users to have specialized hardware.

Bookmarking does not require any end-user storage—other than the storage for the actual application, no storage of video content is required. Actual bookmarks take up less than a standard text message.

Bookmarked videos can be viewed on any device capable of playing Internet video. This can be the device that created the bookmark on or a different device. Examples include a desktop computer, a phone, a tablet, a laptop computer, IP Television, etc. There is no limitation on present or future playback devices other than they need to be able to play a video delivered via the Internet or other similarly capable network.

Creation of bookmarks can be done from any video source in any location and with any content. Examples of bookmark content and location freedom include a television series at home, watching a hockey game in a sports bar, a news broadcast shown in an airport lounge.

End users have complete freedom on where they create bookmarks, what types of content they bookmark, and where they view the associated content from in the future.

### SUMMARY OF THE INVENTION

This invention relates to a network enabled device such as a smart phone, tablet, desktop/laptop computer, television with network capabilities, or other device having interactive functionality which can operate over a network, typically, an Internet Protocol (IP) based network. The device is configured by a suitable application program to enable a user of the device to establish a synchronized relationship with audio/visual content being displayed on a television or other primary display screen (herein referred to as the “primary screen,” the network enabled device is sometimes referred to herein as the “secondary screen device”) and could be a cell phone, tablet, laptop computer, desktop computer or the like. The application enables a user by pressing a “bookmark” or “share” button on the secondary screen device at any time during the viewing of the audio/video content presented on the primary screen, to create a bookmark or digital reference point (share) which represents a particular point in time of the audio/visual content being displayed on the primary screen. This bookmark can be accessed at a later time by the same or any other network enabled device and used to retrieve the audio/visual content and begin playing it beginning at the point in time represented by the created and subsequently accessed bookmark. In this manner, the user can, in effect, save or share the audio/video content for the user or others for future viewing. In one embodiment, to enable sharing of video clips, bookmarks are created with different points in time representing the start time and end time of a video clip or portion of the audio/video content.

More specifically, a user is able to press a bookmark button on an interactive network enabled device while watching audio/video content on a primary screen and then leave the viewing experience and return to watch the balance of the audio/video content at any time in the future using any device with a viewing screen that is capable of accessing and displaying IP based audio/video content. Alternatively, by pressing the button, which may be the same as the bookmark button or a different button, on the network enabled device at the start and at the end of a video segment, thereby identifying a particular video clip, the video clip can then be shared with others by providing a link to the video along with the start and end times of the clip.

### BRIEF DESCRIPTION OF THE DRAWINGS

FIG. 1 shows the processing for obtaining program data for a show currently being shown on a primary screen device using an audio fingerprint.

FIGS. 2a-2g show the processing performed by the secondary screen device, servers and a playback device according to the invention.

FIG. 3 is a block diagram showing the various components needed to perform the processing described with reference to FIGS. 1-2a-2g when utilizing a primary screen and secondary screen device.

FIG. 4 shows the processing for obtaining program data for a show currently being shown on a primary screen device using a set top box.

### DETAILED DESCRIPTION OF THE INVENTION

An application that enables the described functionality can be downloaded by the user into a user's secondary screen device or the application can be pre-installed on a secondary screen device

Using the application, an audio fingerprint is used to determine the program being watched on the primary screen. By way of introduction, an audio fingerprint is created as follows:

1. A microphone on the secondary screen device is activated and begins receiving the audio emitted from speakers associated with the primary screen.

2. Upon acquiring a sample of the audio, the audio sample is processed and an audio fingerprint that can be compared against existing audio fingerprints is created based on the audio sample.

3. The secondary screen device sends the audio fingerprint to an audio fingerprint server for analysis against known audio content.

4. Upon detection of the fingerprint in a known program, the audio fingerprint server returns to the secondary screen device the identification information about the known program such as the name of the show and episode as well as a time corresponding to the fingerprint, that is, a time relative to the beginning of the known program.

5. The secondary screen device displays and/or makes the identification information available on the secondary screen device.

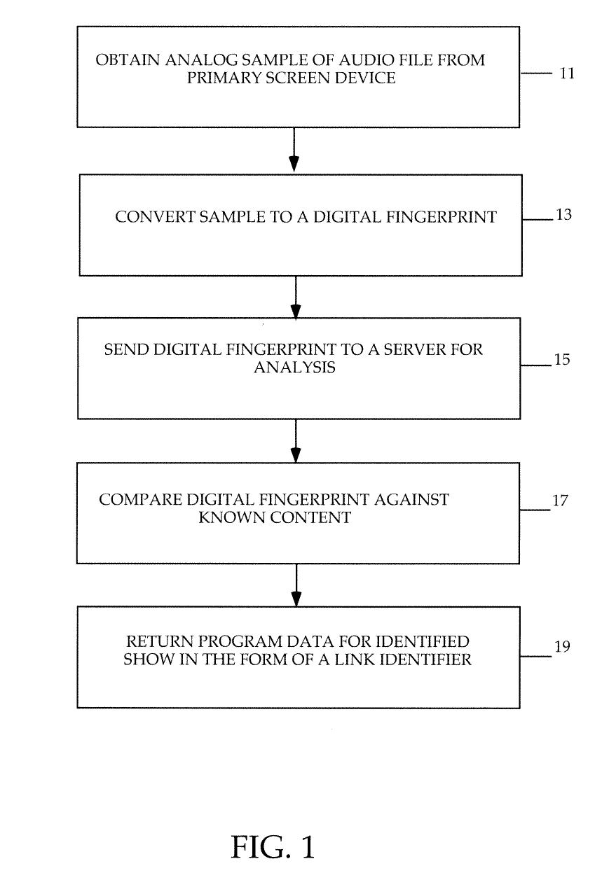

As shown in FIG. 1, audio fingerprinting obtains 11 an analog sample of audio from the primary screen device using a microphone/audio-input associated with the secondary screen device. The analog signal is converted 13 to a digital audio fingerprint. That fingerprint is then sent 15 to a server for analysis and compared 17 against known content for a match. The identified show is then returned 19 in the form of a link notifier which includes a link to a video of the show stored on a server available for access via the Internet.

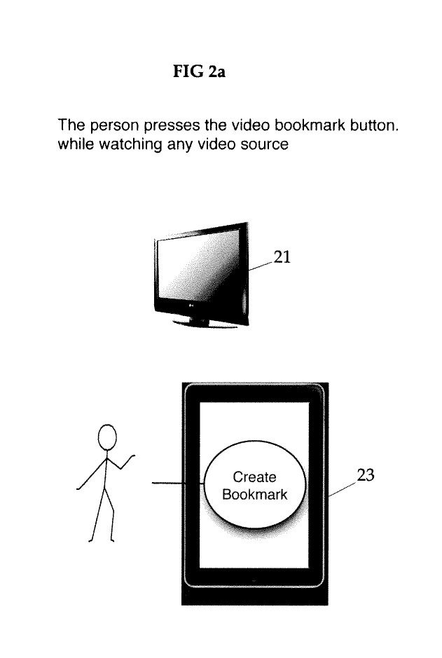

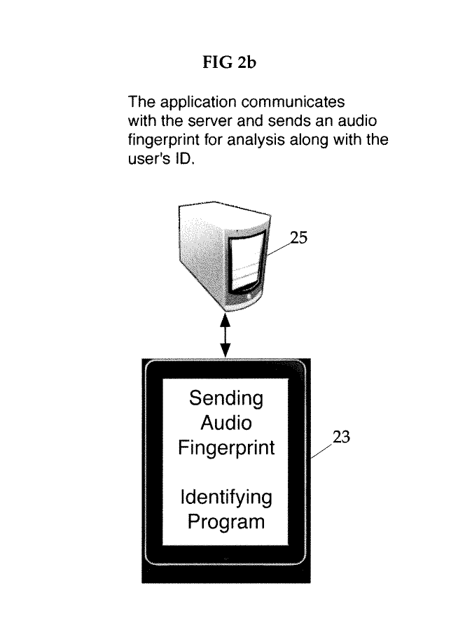

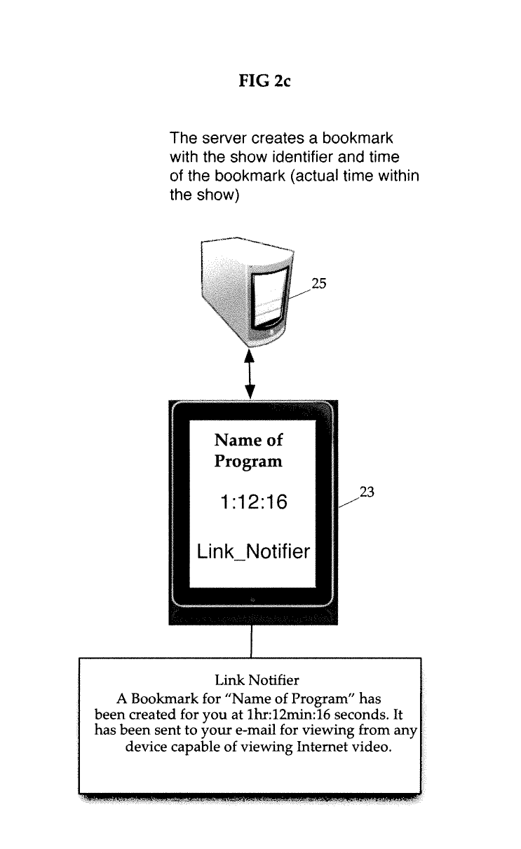

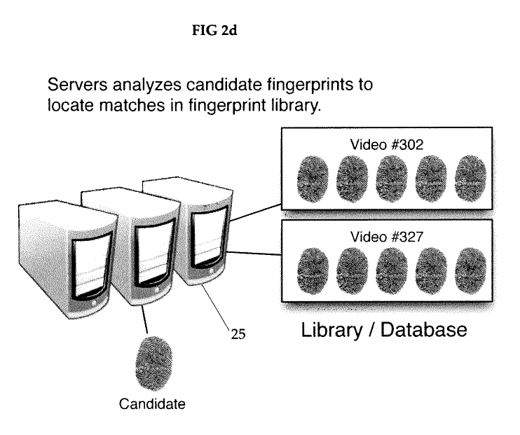

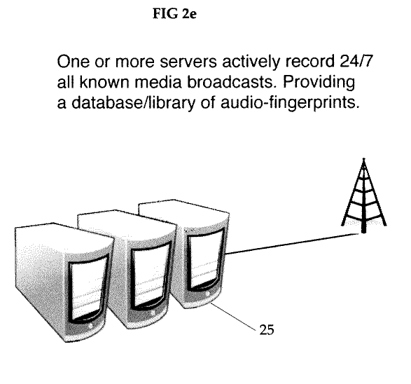

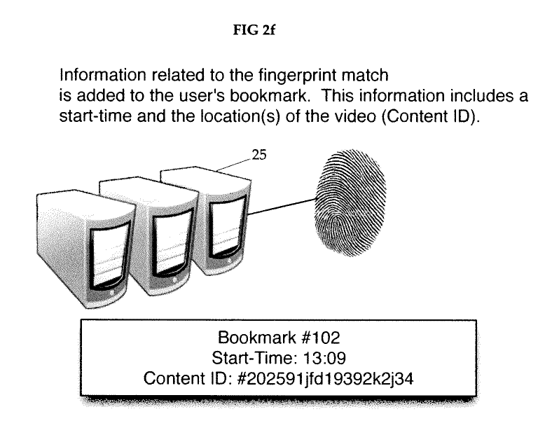

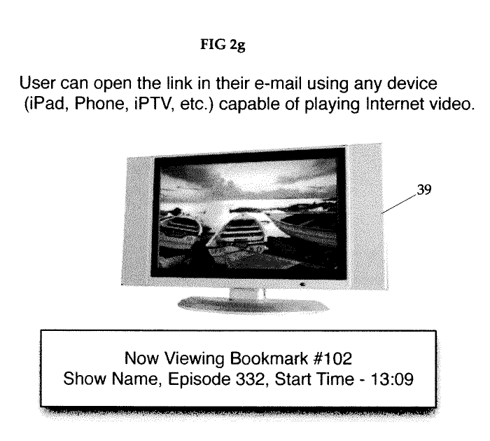

In use, with reference to FIG. 1 and FIG. 2a-2f, while watching a video on the primary screen 21, the user activates the video bookmarking application on a chosen secondary screen device 23 (PC, mobile phone/handheld device, IP-TV, etc.). At that point the application begins sampling audio periodically to enable synchronization. The audio samples are stored locally on the device running the application.

To “bookmark” (mark a point in time within the video) where the user desires to save the location in the video program, as shown in FIG. 2a, the user presses a designated “create bookmark” button (physical or “soft” button, etc.). This initiates a process in which the device looks back into its recorded audio file of periodically sampled audio from the speakers of the primary device 21 and selects a section of audio beginning several seconds from the point at which the user pressed the bookmark button. As shown in FIG. 2b, the audio sample is converted to one or more audio fingerprints packaged as a fingerprint file or stream which is sent to a server 25 along with user identification information. That is, the application on the mobile device creates an audio fingerprint from the audio stream and sends it to the server for matching/location. There are many known solutions for creating audio fingerprints from analog audio samples suitable for use in the invention, the specific details of which are not needed for a proper understanding of the invention.

There are three ways (variations) of handling the actual audio listening portion. The first variation is to listen and periodically record (every 15 seconds of so) an audio sample of several seconds, generate an audio fingerprint from each audio sample and send the generated audio fingerprint to server 25 for identification of the video (e.g., name of TV series and the particular episode) and get the identification back from the server, store the identification locally. The most recently stored identification is the match used when the user hits the bookmark button. This is less bandwidth and battery friendly—but it eliminates the need to wait for an audio capture/match at the time of the user pressing the button. The second variation is to listen when the application first starts up and identify the program whose audio has been sampled from the primary screen device using the above-described audio fingerprint technology and present a picture, logo, etc. which identifies that program once its identity has been determined from the audio fingerprint obtained. The next audio fingerprint occurs when the user presses the button. This next audio fingerprint is used to determine a start time. Since only two audio samples and fingerprints are created and matched, this variation uses less bandwidth and power than the first variation, but will not produce the desired result if for example, the channel is changed on the primary device after startup, or a new program begins. The third variation is to only listen at the point in time where the user presses the bookmark button. The secondary screen device first begins to listen when the bookmark button is pressed. After a few seconds of audio have been captured, a fingerprint is generated and sent to server 25 for identification. In this variation, since the program has not been identified, the server will need to identify program in real time. The benefit to this is that the player does not need to pre-identify a program; therefore it can be used to identify any program and the time within the program without the user needing to first “sync-up” with the program. This method will typically take longer as the server is unable to selectively filter for a specific program and must do an extended search across the entire library.

In all variations, the time determined by the audio fingerprint analysis based on the press of the create bookmark button is used to determine the start (or end in the case where a video clip has been requested by a second button press) associated with the created bookmark. A data store (structured database, data file, etc.) stores at least the following data:
(a) Bookmark ID (Defaults to “Bookmark” followed by the auto-incremented bookmark number which is generated on the secondary screen device). This field can be modified by the user to represent an easily identified title (e.g. My Favorite Show). Category (which represents a specific program identifier provided by server 25). Sub-ID (which represents a specific episode related to the program identifier).
(b) The program start-time (time in seconds from the beginning of the program) of the identified fingerprint.

Additionally, the following data is required in an instance where the end-user creates a clip by pressing the bookmark button a second time or by pressing an alternate button that signifies the “ending time” of the clip:
(c) The program end-time (time in seconds from the beginning of the program) of the identified fingerprint that the clip should end at.

Additionally, the following supplemental (non-required) information is presently seen as useful to end users but not required to allow the present invention to work:
(d) Title of Clip—Program name and episode number.
(e) Date of Original Program—Date of first airing
(f) Program Synopsis—Additional data as provided by the network, show producer, and/or content aggregators providing show and content information.
(g) User Generated Title—A memorable name for clip to aid the user in recalling the clip at a later date/time.

Each data item (a)-(g) is stored on the data store which may be located on server 25, secondary screen device 23 and/or other storage device accessible designated by the user.

At this time, the user may leave the leave the home office or other location where the video was being watched.

Furthermore the user may also be provided with the ability to select a section of the video which is at a point-in-time prior to pressing the bookmark button, e.g. 60 seconds prior, 30 seconds prior, actual start of the video, etc. That is, after fingerprint analysis performed by server 25 has been completed thereby establishing a start time for the determined video, if the capability to select a different start time is provided, the server can simply adjust the start time which is provided accordingly. The adjustment can be a preset user preference or can be made dynamically at any time since once the video has been identified by the provided audio fingerprint, a start time to begin playback can be any time relative to the beginning of the video.

The audio fingerprint is sent to server 25 which receives and, in some embodiments, stores the fingerprint under the identity of the user. The server may also record additional information such as the time/date of the recording and/or other identifying information to aid the user in identifying the video. The server may also assist the user by sending an e-mail message, SMS message, or otherwise notifying the user of the received fingerprint and its “bookmark” via other methods. Furthermore the application on the secondary device may store the bookmark so that the user can access it directly from the device, share it with others, etc.

That is, as shown in FIGS. 2c-2f, the audio fingerprint software on server 25 detects the fingerprint and sends information concerning the identified content back to the secondary screen device 23 as follows. The information provided is 1) Category and Sub-Id; 2) a URL pointing to the actual video content obtained by the server based on the matched audio fingerprint; 3) the current time (in seconds) from the beginning of the specific program identified by the Category and Sub-id. With the obtained URL, the user can use it to access the video. In one embodiment, the obtained URL and other information is also emailed to the user so that the user can readily access the URL and other information at a later time. As shown in FIG. 2e, server 25 receives for the purpose of creating audio fingerprints the audio of all known media broadcasts and creates a library of audio fingerprints. The fingerprint creation is performed by existing systems as explained below.

Preferably, the URL contains other information required for a video server to playback the link as intended by the user. This is as follows:

http://video.network.com?u=3233&v=231-12&s=321

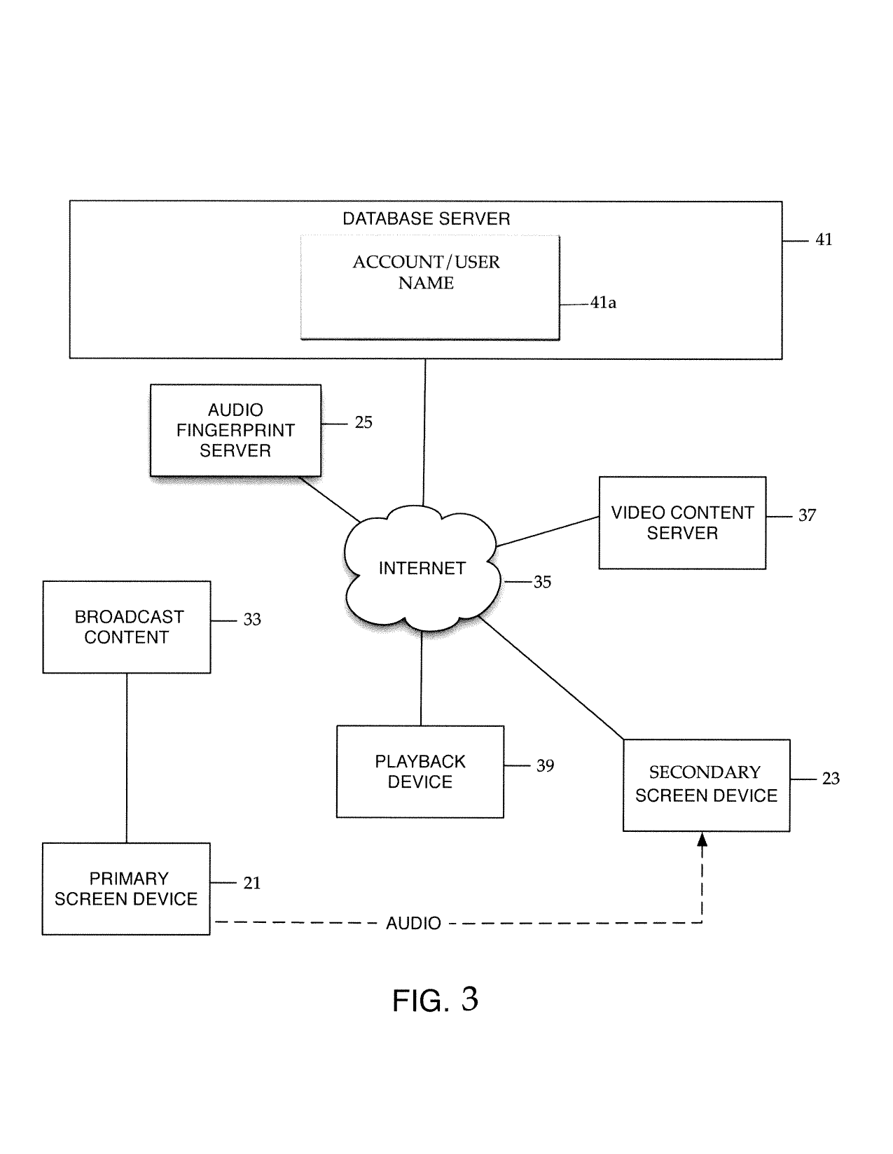

The above URL provides the server name of system storing the video (www.network.com), the user identification of the person that created the video (u=3233), the video ID (Category 231 and Sub-ID 12—v=231-12) and the starting time in seconds (321 or 5 mins 21 seconds). The video server is shown as server 37 in FIG. 3 and will be described in further detail below.

Referring now to FIG. 2g, a web based application resides on the server 37 (not shown in FIG. 2g) to trigger the streaming server to stream a video called 231-12 beginning at 321 seconds based on information provided by a player executing on playback device 39. One such player capable of operating with a seek/start time is JWPlayer, available from Long Tail Video which can be embedded on any web page and called with the above parameters using its preferred format. JWPlayer is a software based player which works inside of a web browser. That is, it is embedded as part of the web page and that page gets sent from the server—including the JWPlayer components as part of it.

The page code then executes from within the browser, including JWPlayer. JWPlayer retrieves the video from a remote server. The player does an initial buffering of a few seconds of the video to determine the video format, duration, frame rate etc. in order to calculate the point within the file (in bytes) that it must seek to in order to begin playing back the video based on the bookmark time. Although JWPlayer is referenced, many different browser based players using HTML5, Flash or other related web technologies may be used providing they can play a video based on a start/end time and seek to a specific time in the video.

Another more robust solution used by larger video streaming sites is the Helix Server available from Real Networks Inc. The Helix Server accepts a start time directly and only streams that portion of video to the end-users video player. In the case of the Helix Server a server-side script accepts the incoming variables from the URL, converts them to an XML file with the clip title, start and stop times and then return a web page with the appropriate player. The Helix server then streams the appropriate video as described in the XML file. A combination of JWPlayer and the Helix Server is seen as the most robust and capable method of providing video across multiple platforms because the Helix player eliminates the need for any buffering to occur on the client-side, and the JWPlayer (or a similar HTML5/Flash based player) can ensure any client with web browser capabilities can play the video stream. This ensures overall compatibility for playback across the widest number of devices.

The secondary screen device may also forward and save the bookmark information (and links for future access) in a “web portal” specifically designed for storing and accessing bookmarks and/or related audio/video content. Such a portal would provide the end-user with access to a personalized library of bookmarks. This might include additional abilities for the user to work with and use bookmarks including:
(a) The ability to sort bookmarks by title, program or date.
(b) The capability to share their bookmarks directly from the portal to major social networks (e.g. FaceBook, Twitter, etc.).
(c) The ability to select a bookmark for immediate playback using the web based video player.
(d) The ability to adjust the start and/or end time of a video (thereby modifying a clip or creating a new one).
(e) The ability to remove bookmarks that are no longer desired.

(f) The ability to locate additional content related to the bookmark's underlying content. (e.g. additional episodes, complete shows, etc.)

As shown in FIGS. 2e-2f, an audio fingerprint server application running on server 25 is designed to scan through the audio portion of available videos (received from networks, producers, through Internet video providers, etc.) and locate a match between the fingerprint and a specific point in any of the available video. This allows the user to return to the same point in a video where the bookmark was created.

The audio fingerprint server application stores video bookmarks and associates them with a particular user and a time within a particular video. Users can return by selecting the link sent by audio fingerprint server 25 in an email and/or by selecting one of the bookmarks available on a website associated with database server 41 under their user ID, and/or by selecting a link in the mobile application. Upon selecting the bookmark, access to the video is obtained by linking to a stored copy on an accessible data network (e.g. a web site on the Internet designed to provide access to pre-recorded videos such as video content server 37, a video producer or television network video library, etc.). The user is presented with the video and it is cued up to the point in time where they chose to associate the bookmark. That is, when the user clicks on the link, video content server 37 determines what video/time correspond with the bookmark in the link and plays it through a web video player such as JWPlayer. The actual web video could be obtained via YouTube™, or Hulu™ or directly through a broadcast network provided service.

The specifics of the techniques utilized to implement the specified functionality on the secondary device and server applications are known to persons skilled in the art, and, therefore, are not detailed herein. Although audio fingerprinting, searching, matching audio portions and the like needed to implement the described functionality is well known, the present invention is directed to novel uses of these techniques as described and claimed herein.

By way of example, if a thirty-minute television program is being watched, its audio is sampled by a microphone local to the television at a particular point in time to create a fingerprint of the audio at that time. Typically, only a few seconds of audio is needed for a match. The entire audio portion which is prerecorded is stored in a format which can be efficiently matched with the created fingerprint of the audio and accessible over the Internet. In some cases, the prerecorded audio stored in a format which can be efficiently matched with the created fingerprint can be stored on the secondary device or another device on the local network. The fingerprint is then compared with the entire audio portion until a match is found. Assuming a match is found, the point in time which corresponds to the program being played on the television is determined thus, in effect, enabling the creation of a bookmark as described above. That is, the user does not need to enter any information related to the program being played.

Techniques for matching relatively small portions of an audio signal with large quantities of previously recorded audio are generally known in the art. One suitable system is a version of Tunatic which is commercially available from Sylvain Demongeot modified to provide the relative time or times of the match. The modified version is also available from Sylvain Demongeot. There may be times when the same fingerprint exists multiple times in the previously recorded audio. In this case, the first time the fingerprint appears is returned. Alternatively, all matched times can be returned and further processing performed to determine the correct one, if possible. Other indicia may be necessary to determine the correct relative time if the first occurrence is not correct. The specifics of the other indicia would depend upon the nature of the content, time of day and/or other factors. The details of such specifics are not needed for a proper understanding of the invention, and, therefore, are not provided.

Referring now to FIG. 2g, the user upon activating the received link to this audio/video content and using a player such as JWPlayer is able to watch the content on any IP enabled device from the point where they originally pressed the bookmark button, or as otherwise adjusted as provided herein.

Many additional features are possible. The user can not only bookmark the current show, but since the metadata from that show is known, all future shows in a series can have a bookmark created if the desired network and time are provided. Of course, a direct URL/link cannot be created for future shows, but with suitable programming at the server, the user can be notified by text or email when a new episode is available.

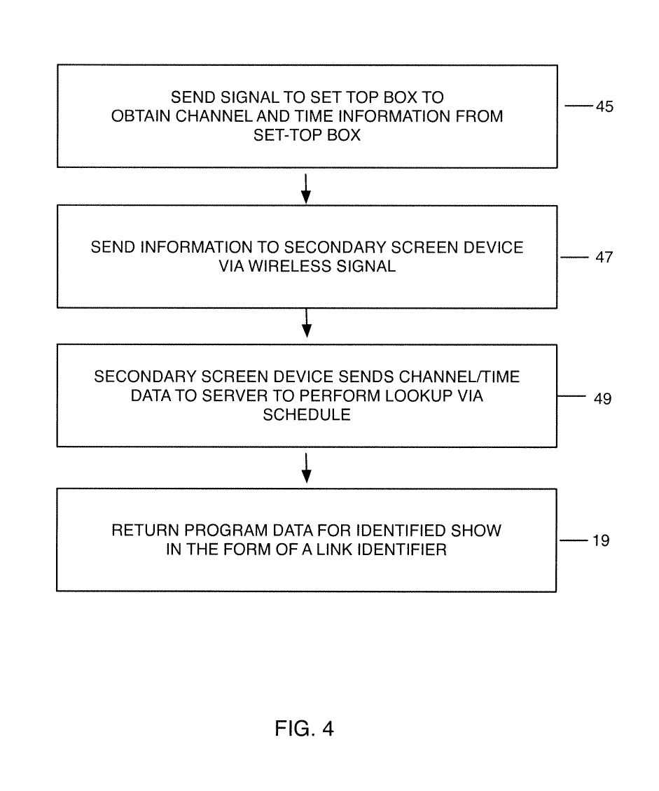

In another embodiment, as shown with reference to FIG. 4, instead of the bookmark button sampling an audio signal and generating a bookmark as described above, upon pressing the bookmark button, a signal is sent 45 to a set top box which is tuned to a particular program to obtain channel and time information. Such a set top box could be any existing set top box modified to include a receiver configured to receive a signal when the bookmark button is pressed, and a transmitter configured to send a signal 47 containing information identifying the show currently tuned to by the set top box. Such information would be the same information provided by fingerprint server after an audio fingerprint has been identified and associated with a particular broadcast, e.g. the show name, episode number and time offset from the beginning of the show when the bookmark button was pressed. Of course, the set top box would also need to be modified to include programming which when triggered by receipt of a signal by the receiver would obtain from existing stored data inside the set top box, and then format such data for sending by the transmitter. Since the set top box and second screen device would be in close proximity, signaling between the set top box and the secondary screen device could be by infrared signals, blue tooth, radio frequencies or other suitable transmission medium, the specifics of which are not important. The secondary screen device then sends 49 the obtained channel/time data to a server, which uses the provided information to return 19 program data in the form of a link identifier as described above with reference to FIG. 2.

### Sharing of Video Clips Functionality

In one embodiment, a share button (referred to in this context as a share button rather than a bookmark button, which button can be the same in both cases, or different, and can be physical buttons or soft buttons) can be pressed on the secondary screen device. On the first push of the share button, a first time in the video is marked (this is the “start time”). On the second push of the button, a second time in the video is marked (this is the “end time”) and stored. Presumably there would be several seconds/minutes between the two presses of the button. The two times that are recorded are the start and stop times of a “clip” of video that the user would like to return to or share with others. The device stores these two times on the device and/or on a server. The two times are used to create two reference time points which operate as explained above, but instead of the audio/video content being played back from the start time of the first bookmark (or a start time adjusted as explained herein) to the end of the content, only the portion between the times stored as the first and second reference time points is played back. Alternatively, rather than storing the start time and end time, upon the first button press, in addition to determining the start time, a timer is started. Upon the second button press, the timer is stopped and the timer amount is added to the start time to obtain the end time. Although the end time can also be determined by sending a second audio fingerprint to the audio fingerprint server when upon the second button press, by calculating the end time using a timer, obviates the need to access the server a second time and having the server match the fingerprint and determine the time.

Now that the program (audio/video content) has been identified using the process above, at the time in point where the user has selected a clip using the share button (pressing once to start and a second time to end), the device stores locally and/or on a server the user identifier, the program identifier and the start/end time of the clip. This data can be used at a future date/time so that the user may recall and view the audio/video content from an IP based audio/video server. At no time does the invention rely on the user recording and/or storing any form of audio/video content. The only data stored is the identification and clip (start/end time) details of the audio/video program.

Upon receiving a clip share as described above, the server can send the user an email (or text message, social-media link and/or any other form of electronic message) that contains a direct URL/link to the “clipped” media content available from a network and/or service that has the selected audio/video content. It may also save the information (and links for future access) in a “web portal” specifically designed for storing and accessing bookmarks and/or related audio/video content by secondary screen devices.

One of the more popular uses for the “share” clips is in sharing content virally via popular sharing social-media sites (Facebook®, Twitter®, etc. and potentially many others in the future). When carried out in this manner, a unique clip link would be shared with others who could then also re-share the same link.

### Client Playback of Video “Clips”

The invention relies on a video player (capable of playing video encoded and accessible using for example HTML5/Javascript, Flash/Action-Script, Apple Quicktime, and technologies related to playback of video, etc.) which can be passed certain parameters for the playback of a local and/or remote video file. Actual choice of video player is based on the specific target “second-screen” device (e.g. tablet device, desktop/laptop computer using a web browser, smart phone or other similar mobile device, IP enabled TV, etc.) and the devices underlying operating system/software and video playback capabilities.

In one example, an HTML5 video player is embedded in the second-screen device application. In another example, that same player is run within a web browser on a desktop computer. In all cases, there are specific parameters required to play a video “clip”. They are:
Source Video—The location of a video file stored and hosted on a remote server.
In-Cue—The point within the video where the clip should begin.
Out-Cue—The point within the video where the clip should end.

In one embodiment the video player is given the location of a video file located on a remote server hosted on the Internet. This video file could be in any number of formats (e.g. QuickTime MP4-.m4v) as long as it can be located and is accessible to the player. The video player on the device is called with the location, in-cue and out-cue parameters. One example of this call as a function sent to a software library capable of playing the video clip is as follows:

openVideo(“http://www.videowebsite.com/videos/show1ep1.m4v”, “73000”, “103000”)

The first parameter is the URL for the video, the second parameter is the start time clip (in-cue) and the third parameter is the end time (out-cue) of the video clip. This particular software library receives the video location/name, and the in-cue/out-cue parameters in this examples are expressed in milliseconds. Thus, 73000 represents 73 seconds, or 1 minute 13, seconds from the start time of the show. Based on the particular function/library and player—the location may be expressed differently, e.g. a different file format or may also include a port for streaming capabilities) and the time format may also be specified differently (e.g. expressed as SMPTE time code, actual time (hours/minutes/seconds), or as numeric pointers representing frame ID's, etc.

The above example triggers the video player to open the video player and play a clip being streamed from the server that starts at one-minute and thirteen seconds into the video and end at one-minute and forty-three seconds.

### Server Storage of “Clips” and the “Video Database”

Server 25 which enables the disclosed functionality is at no point required to store the video files or any segment of the video. It simply needs to store a unique identifier for the video being accessed by the player and the in-cue and out-cue times. In addition, the server needs to know the location of the full videos. However, it is also possible that those operating the server with the required databases could also own/operate file-stores with the complete video assets.

In one embodiment the videos could be located on a number of different servers owned and/or operated by different organizations/individuals. A “video database” stores the list of available servers, the names of the video files and information specific to that video server's formatting. Some videos may have multiple entries in the database referring to multiple locations where additional copies of the video are available; others may be limited to a single location. Furthermore—depending on the video servers being operated, one video provider might operate a specific streaming media video server, and another that operates a different streaming server.

Each time a user creates a clip (and/or shares it with others), the video identifier and the in-cue/out-cue are stored in another database/table/tile. In addition, other information can be obtained and stored which may be pertinent (the user id of the person that selected the clip, and/or the identifiers of other person(s) that the user wants to share the clip with, e.g., e-mail addresses).

With the server 25 knowing the video identifier, the in/out cue times, and information related to the users, it can then associate those pieces of information with a video database which contains information on the location of the videos on a server such as video content server 37. The server 25 can then send information to the application on the second-screen device. An example of this is as follows:

A user selects the start/stop time of a video being watched using the secondary device application as set forth above.

### Server Playback Implementation

The RealNetworks Helix server available from RealNetworks, Inc. located in Seattle, Wash. is one example of a commercially available server that can receive function calls as required and then stream the desired video clip to the device that made the call, and handle all pre-roll capabilities (which is explained below) which can function as video content server 37. Any server having these capabilities can be used-though each will have its own configuration format for call operations and the like. With the Helix server, an XML file is sent to the server that defines the pre-roll information, clip start-time and clip duration in milliseconds. It also provides all required adaptive functions such as streaming at different bit-rates and uses a variety of codecs to allow a large array of potential players to access its streams. It also does adaptive mobile with variable rate buffering to satisfy the needs of a mobile phone accessing things from a 3G network or the like.

### The “Roll-Back” Feature

In one embodiment of the present invention, the application on the secondary screen device initiating the creation of a sharable “clip” can provide the user with the ability to adjust the beginning of the clip to better establish the actual starting time in a case the Share button was pressed at a time later than the intended/desired start time. Two available methods for handling this situation follow:

### a) At the Time of Creation

Upon selecting both the “START” and “END” of a video clip, the secondary screen application displays controls (dials, buttons, or selection-links) permitting the user to adjust the starting time and/or ending time of the clip. One example is a set of dials that provide for adjustment of minutes and seconds. These could be set to any time (1-60 minutes, 1-60 seconds). The application would then do a calculation taking the original start-time (in-cue) and reducing it by the number of minutes/seconds based on the selected values on the dials. This calculated start time would be sent to the server 25 resulting in the clip beginning playback at the users preferred time.

### b) After Creation of Clip

At the point where the server 25 has the program title, in-cue and out-cue it can produce a sample video clip that adds additional time to the clip before the user chose to start the video. It returns a link (URL) via e-mail or otherwise to the creator of the clip and allows the creator to adjust the time (using a dial or a “slider” control) to a more accurate/preferred time.

An example is a video clip that had an in-cue of 5:30 seconds and an out-cue of 8:30 seconds. When the server receives the program title, in-cue and out-cue, it creates a temporary clip beginning at 5:30 seconds and ending at 8:30 seconds. The user that created the clip would then use controls in a player application to adjust the in-cue (e.g. 4:55 seconds). The user would select a “Save” option and the server would then adjust the in-cue to the users preferred time.

### Pre-Roll, Inner-Roll, and Post-Roll Video

When the streaming video server 37 sends the video the video player it is able to add additional video to the beginning or end of the video and/or insert video at any point within the video clip. This allows for advertisement and/or additional information to be presented. One example is a clip that is 10 minutes long. A 15-second pre-roll video would be presented first to the user, followed by the first 5 minutes of the video clip, at which point another clip “inserted video” would play, followed by the second 5 minutes of the video clip, followed by a post-roll video.

The RealNetworks Helix server is one such system which has the capability to add pre-roll video, insert video and post-roll video. By using the “Playlist” feature several start-points, playback durations and source video files can be specified in an XML file that determines what the viewer sees. All video plays through seamlessly as if it were a continuous video from the beginning of the pre-roll through to the end of the post-roll.

FIG. 3 illustrates the various components used to implement one embodiment of the invention. Primary screen device 21, as noted above, is a television or other audio/video display device which need not be connected to any other device which forms part of the invention. Of course, primary screen device will receive broadcast network content 33 from over the air broadcast, cable head-end or any other source of broadcast network content. Such content can also be based on playback from, for example, a DVD player as well since most DVD video content is also audio fingerprint processed. Secondary screen device 23, as noted above, is an interactive network device such as a smart phone, tablet device, desktop computer or the like. The secondary screen device is connected to the Internet 35. Using the described audio fingerprinting technique, an analog audio signal from speakers associated with the primary screen device is received by a microphone associated with the secondary screen device which performs the processing described above. A server 41 maintains an account/username database 41a used as described above to enable a user of a secondary screen device to login to the system to enable the bookmark/sharing as described herein. Server 37 stores the video content to be played back based on bookmark/link information provided by playback device 39. Servers 25, 37 and 41 may be implemented using any commercially available computer with server software. Playback device 39 may be any interactive network device, and, in effect may be the secondary screen device or any other interactive network device capable of audio/video playback of audio/video content available over the Internet. Audio fingerprint server 25 stores audio files which are used to find a match against audio samples created by secondary screen device 23 based on the audio signal produced by the speakers associated with primary screen device 21.

Although FIG. 3 shows three servers, the various databases and video content may exist on a single server or may be spread out among two, three or more servers. The specifics of the computers and server software needed are not important to a proper understanding of the invention, and such specifics are well within the abilities of one skilled in the art based upon the description provided herein. Similarly, the specifics of software used to configure secondary screen devices to operate as set forth herein are not important to a proper understanding of the invention, and such specifics are well within the abilities of one skilled in the art based upon the description provided herein.

Although various specific implementation details have been set forth herein, such details should not be construed as limiting the invention as defined in the following claims.

I claim:

1. A method for identifying video segments for subsequent playback comprising:
a) retrieving audio from an audio-visual presentation playing on a primary screen device using a secondary screen device;
b) generating at least one audio fingerprint from the retrieved audio;
c) sending the at least one audio fingerprint to an audio fingerprint server;
d) obtaining from the audio fingerprint server information identifying the audio-visual presentation and a relative time within the audio-visual presentation corresponding to the at least one audio fingerprint, said obtained information usable for subsequently retrieving said audio video presentation from a video content server.

2. The method defined by claim 1 further comprising:
a) generating a second relative time within the audio-visual presentation;
b) storing the second relative time for use during playback of the audio-visual presentation on at least one of the secondary screen device, the audio fingerprint server and a user account server.

3. The method defined by claim 1 further comprising storing the obtained audio fingerprint server information on at least one of the secondary screen device, the audio fingerprint server and a user account server.

4. The method defined by claim 1 further comprising sending information to the audio fingerprint server identifying a user of the secondary screen device.

5. The method defined by claim 1 further comprising:
a) obtaining a link to the obtained information;
b) sending the link to an audio-visual content server;
c) receiving from the audio-visual content server a video stream corresponding to the identified audio-visual presentation for playback.

6. The method defined by claim 1 further comprising adjusting the relative time to one of a predetermined earlier time and a predetermined later time.

7. The method defined by claim 6 wherein the predetermined earlier time is a start time of the audio-video presentation.

8. The method defined by claim 1 wherein said retrieving comprises one of recording a single sample of said audio and recording periodic samples of said audio.

9. The method defined by claim 1 wherein said generating comprises one of generating a single audio fingerprint from a single sample of said audio and generating a plurality of audio fingerprints from a plurality of samples of said audio.

10. The method defined by claim 1 further comprising using the obtained audio fingerprint server information to download to a playback device from an audio-visual content server the identified audio video presentation beginning at a predetermined time.

11. The method defined by claim 2 further comprising using the obtained audio fingerprint server information to download to a playback device from an audio-visual content server the identified audio video presentation beginning at a predetermined time and ending at the second relative time.

12. A method for identifying video segments in for subsequent playback comprising:
a) receiving an audio fingerprint from a secondary screen device;
b) comparing the received audio fingerprint with pre-existing audio fingerprints for a match;
c) upon determining said match, determining an identity of an audio-visual presentation corresponding to said match and a relative time within said audio-visual presentation corresponding to said match;
d) sending said identity and relative time to said secondary screen device.

13. The method defined by claim 12 further comprising:
a) receiving a second relative time within said audio-visual presentation from the secondary screen device;
b) storing the second relative time.

14. A system for identifying video segments for subsequent playback comprising:
a) an audio fingerprint server configured to:
1) receive at least one audio fingerprint from a secondary screen device;
2) compare the at least one received audio fingerprint with pre-existing audio fingerprints for a match;
3) upon determining said match, determine an identify of an audio-visual presentation corresponding, to said match and a relative time within said audio-visual presentation corresponding to said match;
4) send said identity and relative time to at least one of said secondary screen device and a predetermined address designated by a user of said secondary device;
b) an account database server accessible by said audio fingerprint server configured to store user information corresponding to the user of said secondary device.

15. The system defined by claim 14 wherein the audio fingerprint server is further configured to store said identity and relative time and user information for subsequent retrieval by said user for use in playing back at least a portion of said audio-visual presentation.

16. A method for identifying video segments for subsequent playback comprising:
a) sending a signal to a set top box which is tuned to a particular audio-visual presentation;
b) obtaining from the set top box information identifying the audio-visual presentation and a relative time within the audio-visual presentation corresponding to the time the signal was sent to the set top box, said obtained information usable for subsequently retrieving said audio video presentation from a video content server.
